(19) United States
(12) Patent Application Publication
(10) Pub. No.: US 2026/0035981 A1
(43) Pub. Date: Feb. 5, 2026

(54) DOOR OPENING AND CLOSING APPARATUS FOR VEHICLE

(71) Applicant: SL Corporation, Daegu (KR)

(72) Inventors: Yong Woo PARK, Gyeongsan-si (KR); Chang Su LEE, Gyeongsan-si (KR)

(21) Appl. No.: 19/231,758

(22) Filed: Jun. 9, 2025

(30) Foreign Application Priority Data
Jul. 23, 2024 (KR) 10-2024-0097181

(51) Int. Cl. E05F 15/622; F16H 57/02; F16H 57/021

(52) U.S. Cl. CPC E05F 15/622; F16H 57/021; E05Y 2201/21; E05Y 2201/258; E05Y 2201/72; E05Y 2600/46; E05Y 2600/626; E05Y 2900/531; F16H 2057/02034; F16H 2057/02082

(57) ABSTRACT

A door opening and closing apparatus for a vehicle includes a lead screw hinge-coupled to one of a door or a body of the vehicle; and an opening and closing module coupled to the other thereof, the opening and closing module being arranged such that the lead screw passes through a center of the opening and closing module, and configured to move to a first side of the lead screw to close the door or to a second side of the lead screw to open the door. The opening and closing module includes a drive module configured to provide a rotation that is converted to linear reciprocation of the opening and closing module relative to the lead screw; and a planetary gear reduction module configured to transmit the rotation of the drive module at a preset gear reduction ratio.

### CROSS-REFERENCE TO RELATED APPLICATION

This application claims priority from Korean Patent Application No. 10-2024-0097181, filed on Jul. 23, 2024, which is incorporated herein by reference in its entirety.

### BACKGROUND

### 1. Technical Field

The present disclosure relates to a door opening and closing apparatus for a vehicle, and more particularly, to a door opening and closing apparatus for a vehicle that is capable of automatically opening and closing a vehicle door.

### 2. Description of the Related Art

In general, the importance of vehicles in modern life is continuously increasing, and accordingly, various devices are being installed in vehicles not only for driving stability or ride comfort but also to enhance the convenience of drivers.

For example, one of the most commonly used methods for opening and closing a vehicle door involves a passenger directly pushing or pulling the door. In such cases, situations may arise where it is difficult to operate the door due to the slope of the road where the vehicle is located, or the door may suddenly open or close due to strong wind or its own weight.

As such, when the force required for the passenger to push or pull the door increases or when the door suddenly opens or closes, consumer experience can be diminished, and the risk of injury to the passenger or nearby pedestrians increases. Therefore, a demand for reducing the required operating force while also preventing unintentional door closure has developed.

### SUMMARY

An objective of the present disclosure is to provide a door opening and closing apparatus for a vehicle that assists in opening and closing a vehicle door without requiring a passenger to push or pull the door.

Another objective of the present disclosure is to provide a vehicle actuator that can control friction differently depending on the rotation direction of a shaft when the shaft is rotated by an external force with the motor stopped.

The objectives of the present disclosure are not limited to those mentioned above, and other objectives not explicitly stated will be clearly understood by those skilled in the art based on the following description.

According to an aspect of the present disclosure, a door opening and closing apparatus for a vehicle may include a lead screw hinge-coupled to one of a door or a body of the vehicle; and an opening and closing module coupled to the other of the door or the body, the opening and closing module being arranged such that the lead screw passes through a center of the opening and closing module, and configured to move to a first side of the lead screw to close the door or to a second side of the lead screw to open the door. The opening and closing module may include a drive module configured to provide a rotation that is converted to linear reciprocation of the opening and closing module relative to the lead screw; and a planetary gear reduction module configured to transmit the rotation of the drive module at a preset reduction ratio. The lead screw may be disposed along a rotation center of the drive module.

In some embodiments, the planetary gear reduction module may include a gear housing; a sun gear coupled to a rotor provided at the rotation center of the drive module; a plurality of first planet gears disposed between the sun gear and the gear housing; and an output gear rotatably coupled to the first planet gears, the output gear being rotated by a revolution of the first planet gears to move relative to the lead screw.

In some embodiments, the planetary gear reduction module may include a gear housing; a sun gear coupled to a rotor provided at the rotation center of the drive module; a plurality of first planet gears disposed between the sun gear and the gear housing; a carrier having a first side to which the first planet gears are rotatably coupled, the carrier being rotated due to a revolution of the first planet gears; a plurality of second planet gears disposed around a central gear provided on a second side of the carrier; and an output gear rotatably coupled to the second planet gears, the output gear being rotated by a revolution of the second planet gears to move relative to the lead screw.

The door opening and closing apparatus for a vehicle may further include a boot cover provided between a first end of the gear housing and a first end of the lead screw to surround the lead screw.

The door opening and closing apparatus for a vehicle may further include a bushing or bearing that supports a first end of the rotor at a second end of the gear housing.

The drive module may include a hollow rotor; a brushless direct current (BLDC) motor that provides a torque to the rotor; and a motor housing that surrounds an exterior of the drive module and coupled to the planetary gear reduction module.

The drive module may further include a magnet brake disposed between a second end of the rotor and the motor housing. The magnet brake may include a first magnetic body provided on an outer circumferential surface of the second end of the rotor; and a second magnetic body provided on an inner circumferential surface of a second end of the motor housing and arranged to face the first magnetic body. The magnet brake may interfere with rotation of the rotor at one or more preset positions by generating magnetic attraction between the rotor and the motor housing as the first magnetic body and the second magnetic body, having opposite polarities, are arranged to face each other.

The door opening and closing apparatus for a vehicle may further include a bracket coupled to the other of the door or the body, and the opening and closing module may be rotatably coupled to the bracket.

The door opening and closing apparatus for a vehicle of the present disclosure may provide the following effects.

First, since a vehicle door can be opened or closed without requiring a passenger to push or pull it, the vehicle door can be operated more conveniently.

Second, since the opening and closing module is configured parallel to the rotation axis of a lead screw, it can be made relatively compact and lightweight.

Third, by including a magnet brake, it is possible to prevent unintended closure of the vehicle door.

It should be noted that the effects of the present disclosure are not limited to those described above, and other effects of the present disclosure will be apparent from the following description.

### BRIEF DESCRIPTION OF THE DRAWINGS

The detailed description of the exemplary embodiments of this application described below, as well as the summary described above, will be better understood when read in conjunction with the accompanying drawings. The drawings illustrate exemplary embodiments of the present disclosure for illustrative purposes. However, it should be understood that the application is not limited to the exact arrangements and means shown.

FIG. 1 is a perspective view illustrating a portion of a vehicle to which a door opening and closing apparatus for a vehicle according to an embodiment of the present disclosure is mounted.

FIG. 2 is a perspective view illustrating the door opening and closing apparatus for a vehicle in FIG. 1.

FIG. 3 is an exploded perspective view illustrating the door opening and closing apparatus for a vehicle in FIG. 2.

FIG. 4 is a longitudinal cross-sectional view illustrating the door opening and closing apparatus for a vehicle when the door in FIG. 1 is closed.

FIG. 5 is a longitudinal cross-sectional view illustrating the door opening and closing apparatus for a vehicle when the door in FIG. 1 is opened.

FIG. 6 is an exploded perspective view illustrating the planetary gear reduction module of the door opening and closing apparatus for a vehicle in FIG. 3.

FIG. 7 is an enlarged view illustrating part of the planetary gear reduction module of the door opening and closing apparatus for a vehicle in FIG. 4.

FIG. 8 is an enlarged view illustrating part of the drive module of the door opening and closing apparatus for a vehicle in FIG. 4.

FIG. 9 is an exploded perspective view illustrating a planetary gear reduction module of the door opening and closing apparatus for a vehicle according to another embodiment of the present disclosure.

### DETAILED DESCRIPTION

Since the present disclosure can be modified variously and can include various embodiments, specific embodiments will be illustrated and described in the drawings. However, this is not intended to limit the present disclosure to such specific embodiments, and it should be understood to include all modifications, equivalents, and alternatives within the spirit and scope of the disclosure.

Terms including ordinal numbers such as first, second, etc., may be used to describe various components, but these components are not limited by these terms.

These terms are used only to distinguish one component from another. For example, a second component can be named a first component without departing from the scope of the disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present.

Conversely, when a component is said to be “directly connected to” or “directly coupled to” another component, there are no intervening components.

The terms used in this application are for the purpose of describing particular embodiments only and are not intended to limit the disclosure.

Unless the context clearly indicates otherwise, the singular forms include the plural forms as well.

In this application, the terms “comprising” or “having” are intended to specify the presence of stated features, numbers, steps, operations, elements, components, or combinations thereof, but do not preclude the presence or addition of one or more other features, numbers, steps, operations, elements, components, or combinations thereof.

Embodiments will hereinafter be described with reference to the accompanying drawings, wherein the same or corresponding components, regardless of the drawing numbers, are assigned the same reference numbers, and redundant descriptions will be omitted.

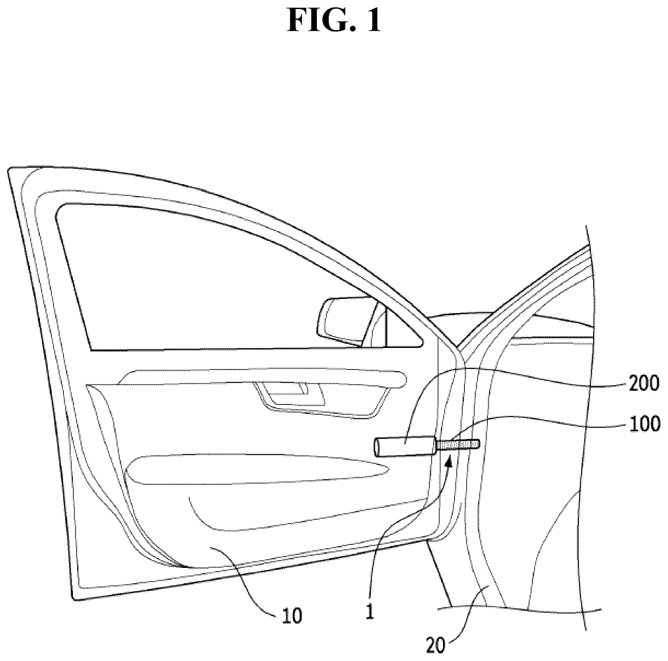

FIG. 1 is a perspective view illustrating a portion of a vehicle to which a door opening and closing apparatus for a vehicle according to an embodiment of the present disclosure is mounted.

Referring to FIG. 1, a door opening and closing apparatus 1 for a vehicle according to an embodiment of the present disclosure may be installed between a door 10 and a body 20 of a vehicle so that the door 10 can be opened or closed without requiring a passenger to pull or push the door 10 when boarding or disembarking the vehicle, thereby improving passenger convenience. The door opening and closing apparatus 1 may also allow the passenger to more easily open the door 10 in a situation where the door 10 is difficult to open due to the slope of the road where the vehicle is located or strong wind, and may prevent the door 10 from unintentionally closing due to road slope or strong wind while the door 10 is in an open state.

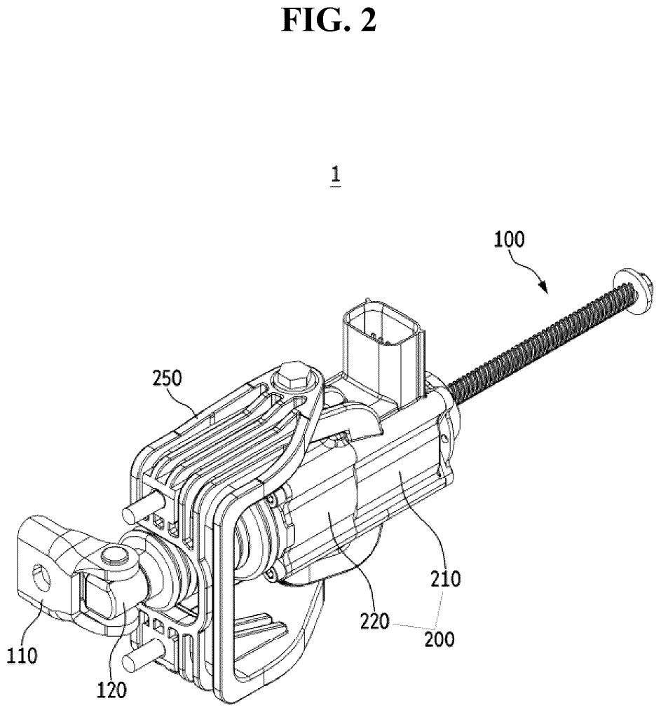

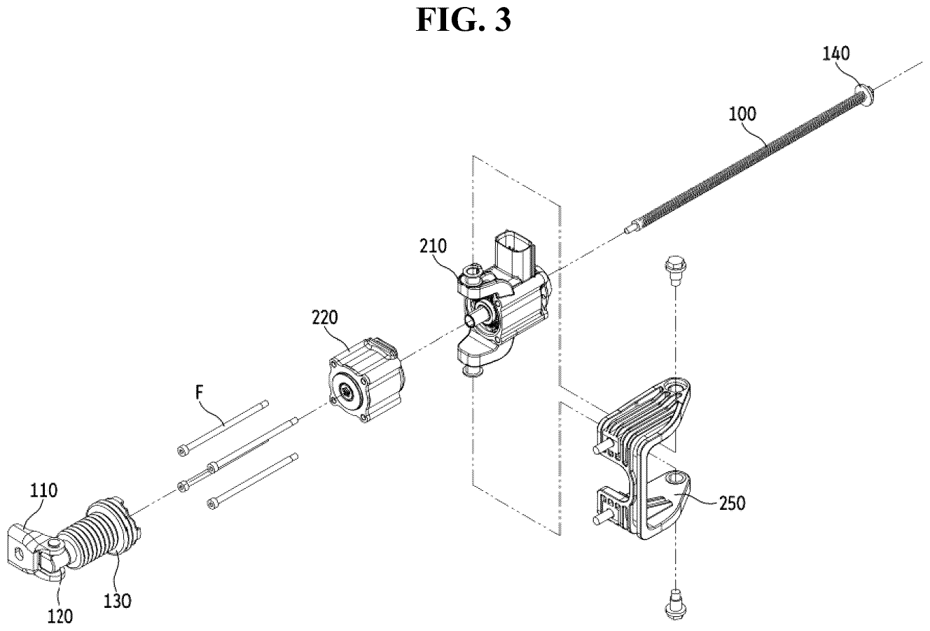

FIG. 2 is a perspective view illustrating the door opening and closing apparatus for a vehicle in FIG. 1, and FIG. 3 is an exploded perspective view illustrating the door opening and closing apparatus for a vehicle in FIG. 2.

Referring to FIGS. 2 and 3, the door opening and closing apparatus 1 may include a lead screw 100 (e.g., a threaded rod) and an opening and closing module 200.

First, the lead screw 100 may be installed on one of the door 10 or the body 20 of the vehicle, and the opening and closing module 200 may be installed on the other of the door 10 or the body 20. In this embodiment, for example, one side of the lead screw 100 may be fixed to the body 20 of the vehicle, and the opening and closing module 200 may be installed on the door 10. Alternatively, the lead screw 100 may be fixed to the door 10, and the opening and closing module 200 may be installed on the body 20.

The lead screw 100 may include a first hinge member 110 configured to be fixed to the body 20 of the vehicle, and a second hinge member 120 rotatably coupled to the first hinge member 110. The first and second hinge members 110 and 120 may function as a bracket that bendably couples the lead screw 100 to the body 20 of the vehicle. The lead screw 100 may be coupled to the interior of an end of the second hinge member 120, and one side of a boot cover 130 may be coupled to the exterior of the second hinge member 120.

The opening and closing module 200 may include a drive module 210 and a planetary gear reduction module 220. The drive module 210 and the planetary gear reduction module 220 may be fastened to each other by fasteners F.

The drive module 210 may provide rotational actuation, which then can be converted to linear reciprocation of the opening and closing module 200 with respect to the lead screw 100.

In addition, the planetary gear reduction module 220 may transmit the rotational force of the drive module 210 at a preset reduction ratio. That is, the drive module 210 may provide rotational force to the planetary gear reduction module 220, which engages with threads formed on the outer circumferential surface of the lead screw 100. As a result, the opening and closing module 200 may linearly reciprocate relative to the lead screw 100, thereby allowing the door 10 to be opened or closed relative to the body 20 of the vehicle.

The lead screw 100 may be disposed through the center of the drive module 210 and the planetary gear reduction module 220, and may pass through the center of the opening and closing module 200, thereby performing the opening and closing operation of the door 10. In other words, since the mechanism for relative movement of the opening and closing module 200 with respect to the lead screw 100 is arranged in parallel with or around the lead screw 100, the structure of the door opening and closing apparatus 1 can be made lightweight and compact.

Also, the boot cover 130 may be provided between one side of the planetary gear reduction module 220 and a first end of the lead screw 100. The boot cover 130 may protect the lead screw 100 from being exposed to the outside.

The opening and closing module 200 may further include a bracket 250 for coupling to the body 20 of the vehicle. The bracket 250 may fix the opening and closing module 200 on the door 10 so as to be rotatable. In this embodiment, for example, the bracket 250 may be connected to a motor housing 214 of the drive module 210, or alternatively to a gear housing 221 of the planetary gear reduction module 220.

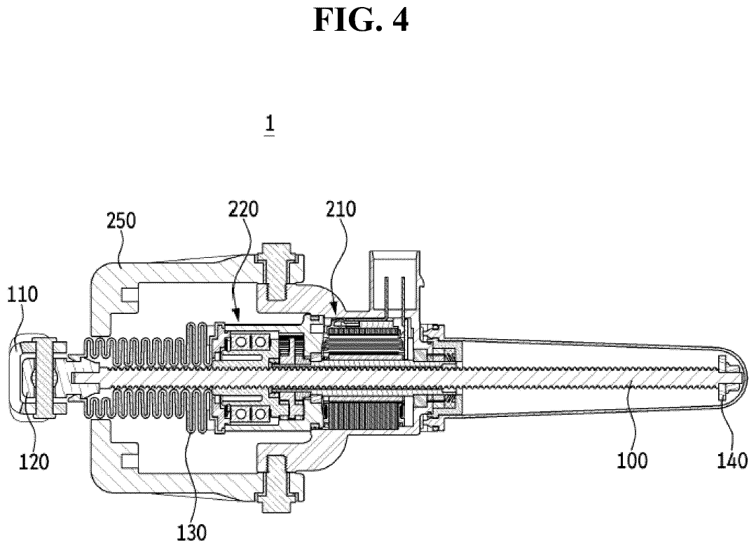

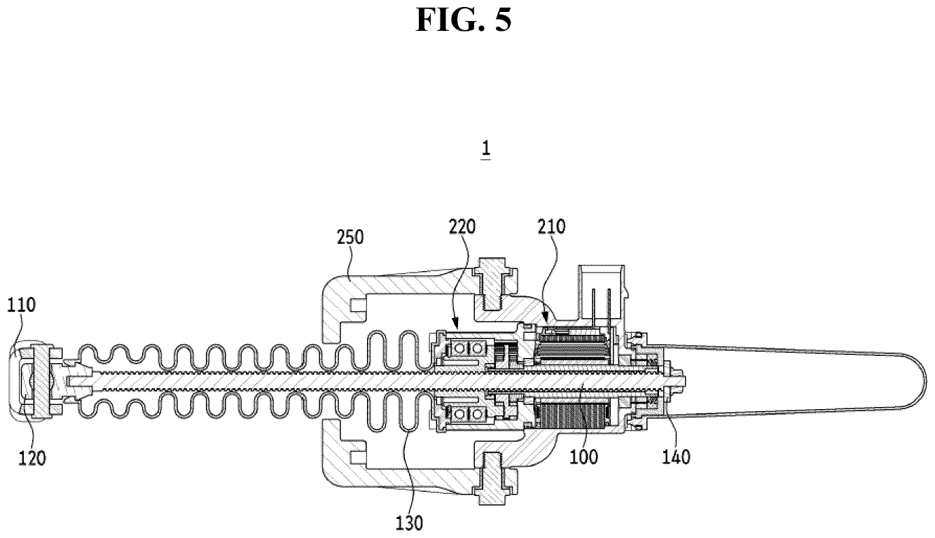

FIG. 4 is a longitudinal cross-sectional view illustrating the door opening and closing apparatus for a vehicle when the door in FIG. 1 is closed, and FIG. 5 is a longitudinal cross-sectional view illustrating the door opening and closing apparatus for a vehicle when the door in FIG. 1 is opened.

Referring to FIGS. 4 and 5, the door opening and closing apparatus 1 may rotate in one direction about the lead screw 100 so that the opening and closing module 200 may move adjacent to a first side of the lead screw 100, thereby closing the door 10 (FIG. 4). Conversely, the door opening and closing apparatus 1 may rotate in the other direction about the lead screw 100 so that the opening and closing module 200 may move adjacent to a second side of the lead screw 100, thereby opening the door 10 (FIG. 5).

At this time, when the opening and closing module 200 moves to the first side of the lead screw 100, the boot cover 130 may be compressed. When the opening and closing module 200 moves to the second side of the lead screw 100, the boot cover 130 may be extended. Therefor, the boot cover 130 may be implemented as a bellows. Accordingly, regardless of the position of the opening and closing module 200, the boot cover 130 may cover the lead screw 100 from the first side of the lead screw 100 to the portion of the lead screw 100 to which the opening and closing module 200 has moved.

Further, a stopper 140 for limiting the stroke distance of the opening and closing module 200 may be provided at a second end of the lead screw 100.

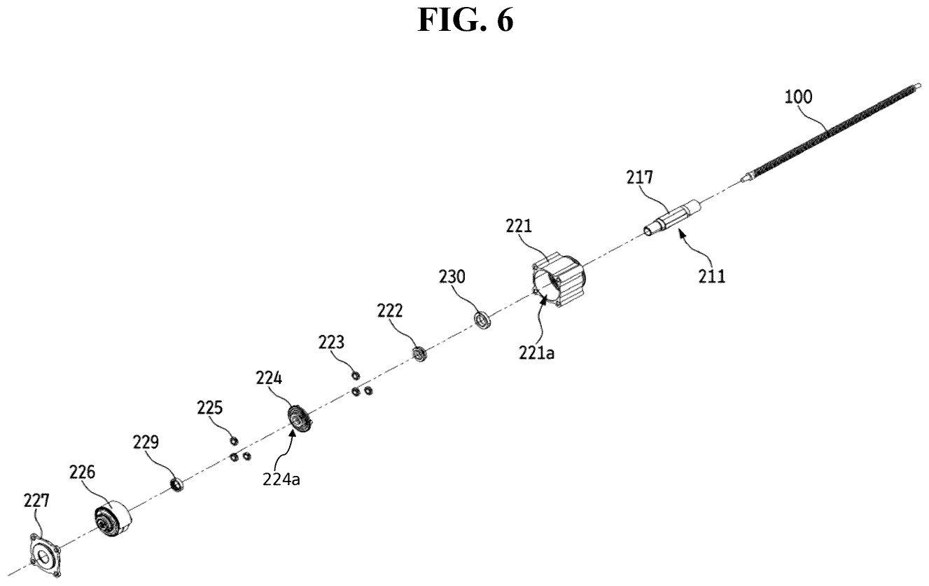

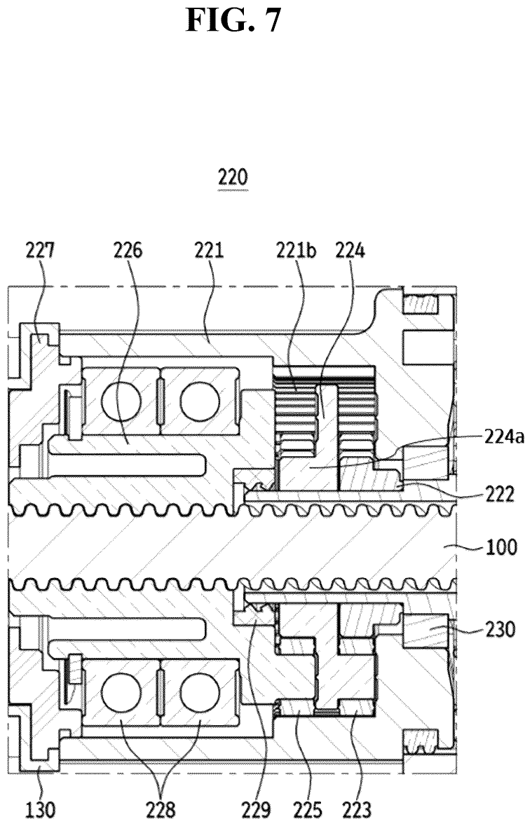

FIG. 6 is an exploded perspective view illustrating the planetary gear reduction module of the door opening and closing apparatus for a vehicle in FIG. 3, and FIG. 7 is an enlarged view illustrating part of the planetary gear reduction module of the door opening and closing apparatus for a vehicle in FIG. 4.

Referring to FIGS. 6 and 7, the planetary gear reduction module 220 of the door opening and closing apparatus 1 may include a gear housing 221, a sun gear 222, first pinion gears 223, a carrier 224, second pinion gears 225, and an output gear 226.

The gear housing 221 may form the outer shape of the planetary gear reduction module 220 and may have an accommodation space 221a for rotatably accommodating the sun gear 222, the first pinion gears 223, the carrier 224, the second pinion gears 225, and the output gear 226. A cover 227 that closes the accommodation space 221a may be coupled to a first side of the gear housing 221, and a second side of the boot cover 130 may be coupled to the outer side of the cover 227. An outer gear 221b may be formed on the inner circumferential surface of the gear housing 221. The outer gear 221b may engage with the planetary gear reduction module 220 to be described later.

In addition, the sun gear 222 may be coupled to a first end of a rotor 211 of the drive module 210 to be described later and may be disposed inside the gear housing 221. The sun gear 222 may transmit rotational force provided from the drive module 210 to the planetary gear reduction module 220.

Further, a plurality of first pinion gears 223 may be disposed around the sun gear 222 and receive rotational force from the sun gear 222. In this embodiment, for example, three first pinion gears 223 may be arranged equiangularly or at equal intervals around the sun gear 222, and may each be arranged to simultaneously engage with the outer gear 221b. Here, the first pinion gears 223 may function as planet gears that revolve around the sun gear 222 while rotating about their own axes.

Further, each of the first pinion gears 223 may be rotatably coupled to a first side of the carrier 224. The carrier 224 may be rotated as the first pinion gears 223 revolve and rotate. A central gear 224a may protrude integrally from a second side of the carrier 224.

Additionally, a plurality of second pinion gears 225 may be provided around the central gear 224a at the second side of the carrier 224. The second pinion gears 225 may receive rotational force from the rotation of the central gear 224a and may be arranged to engage with the outer gear 221b.

Further, the second pinion gears 225 may be rotatably coupled to the output gear 226. The output gear 226 may be coupled such that the second pinion gears 225 can revolve and rotate, and threads may be formed on the inner circumferential surface of the output gear 226 to engage with the lead screw 100. The output gear 226 may rotate with an increased torque and reduced-speed around the lead screw 100. The output gear 226 may be rotatably supported within the gear housing 221 by at least one bearing 228.

A sealing member 229 for preventing foreign substance from entering through a first end of the rotor 211 may be provided between the output gear 226 and the central gear 224a of the carrier 224. In addition, at a region adjacent to the drive module 210 on the second side of the gear housing 221, a bushing or bearing 230 for supporting the first end of the rotor 211 may further be provided.

Therefore, when the sun gear 222 rotates, the first pinion gears 223, the carrier 224, and the second pinion gears 225 may rotate, ultimately rotating the output gear 226. The output gear 226 may rotate about the lead screw 100, thereby causing the opening and closing module 200 to move relative to the lead screw 100 along its longitudinal direction.

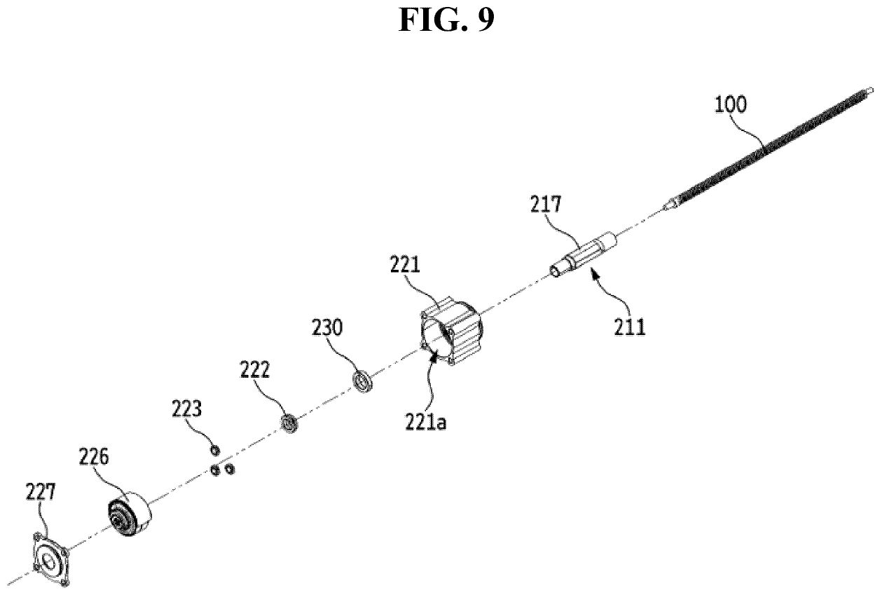

Referring to FIG. 9, in some embodiments, the planetary gear reduction module 220 may be configured with a structure including the gear housing 221, the sun gear 222, the first pinion gears 223, and the output gear 226, without the central gear 224a and the second pinion gears 225 involved. In this case, the first pinion gears 223 may be rotatably coupled to the output gear 226, thereby allowing the output gear 226 to effectively function as the carrier 224.

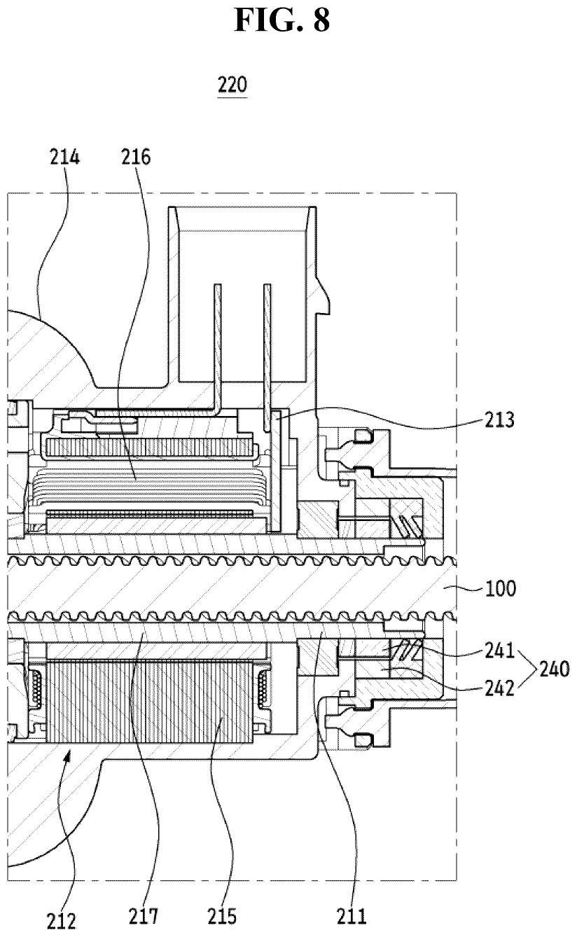

FIG. 8 is an enlarged view illustrating part of the drive module of the door opening and closing apparatus for a vehicle in FIG. 4. Referring to FIG. 8, the drive module 210 of the door opening and closing apparatus 1 may include the rotor 211, a motor 212, a motor sensor 213, and a motor housing 214.

The rotor 211 may be formed as a shaft with a hollow structure going therethrough and may be arranged to be passed through by the lead screw 100. Preferably, the rotor 211 may be arranged not to interfere with the lead screw 100 inside. The rotor 211 may correspond to the output shaft of the motor 212.

The motor 212 may be implemented as a brushless direct current (BLDC) motor. The BLDC motor may include a stator 215 and coils 216. The rotor 211 may include a permanent magnet 217. Thus, depending on the position of the permanent magnet 217, current may flow through the coils to generate magnetic flux, thereby rotating the rotor 211. The structure of the BLDC is known, and thus, a further detailed description thereof will be omitted.

The motor sensor 213 may detect the magnetic field of the permanent magnet 217 attached to the rotor 211. Accordingly, the motor sensor 213 may count the number of rotations based on the detected magnetic field of the permanent magnet 217 and estimate the axial position of the lead screw 100.

The motor housing 214 may form the outer shape of the drive module 210 and may accommodate the rotor 211 and the motor 212 therein. A first side of the motor housing 214 may be coupled to the second side of the gear housing 221, and a magnet brake 240 may be provided on a second side of the motor housing 214.

The magnet brake 240 may include a first magnetic body 241 provided in a donut shape at the other end of the rotor 211, and a second magnetic body 242 provided on the inner circumferential surface of the second side of the motor housing 214. The first and second magnetic bodies 241 and 242 may be arranged to face each other across a circumferential direction at the other end of the rotor 211.

At least one of the first magnetic body 241 or the second magnetic body 242 may be implemented as an electro-magnet. When the first and second magnetic bodies 241 and 242 are configured (e.g., by applying current) to have opposite polarities and thus attract each other, the magnet brake 240 may interfere with rotation between the rotor 211 and the motor housing 214 at a preset position due to magnetic attraction, thereby stopping the door 10 at the preset position. Here, the rotational force of the rotor 211 driven by the motor 212 may be greater than the magnetic attraction of the magnet brake 240, and when the motor 212 is actively rotated, the retardation by the magnet brake 240 may be overridden due to the motor 212 and the rotor 211 may continue rotating. When the rotation of the motor 212 is interrupted, however, the magnet brake 240 may stop the door 10 at a preset position. A plurality of positions, at which the door 10 is stopped, that is, where the door 10 is held by the magnet brake 240, may be preset. For example, the preset stop positions of the door 10 by the magnet brake 240 may include a partially open position, a half-open position, and a fully open position of the door 10.

The magnetic attraction of the magnet brake 240 may be released when the motor 212 rotates.

By stopping the door 10 at each preset position using the magnet brake 240, it is possible to prevent the door 10 from being opened or closed at an excessive speed and to prevent the door 10 from unintentionally closing due to an external force such as wind while in an open state.

Therefore, according to the door opening and closing apparatus for a vehicle of the present disclosure, a vehicle door can be opened or closed without requiring a passenger to push or pull it, thereby improving passenger convenience. Since the opening and closing module is arranged in parallel with the rotation axis of the lead screw, the door opening and closing apparatus for a vehicle can be made relatively compact and lightweight. Also, by including a magnet brake, it is possible to prevent the vehicle door from suddenly closing contrary to the passenger's intention.

While the technical idea of the disclosure has been illustrated and described in detail with reference to specific embodiments, the present disclosure is not limited to the specific configurations and operations of these embodiments. Various modifications can be made within the scope of the disclosure without departing from its spirit. Therefore, such modifications should be considered within the scope of the disclosure, and the scope of the disclosure should be determined by the appended claims.

What is claimed is:

1. A door opening and closing apparatus for a vehicle, comprising:
a lead screw hinge-coupled to one of a door or a body of the vehicle; and
an opening and closing module coupled to the other of the door or the body, the opening and closing module being arranged such that the lead screw passes through a center of the opening and closing module, and configured to move to a first side of the lead screw to close the door or to a second side of the lead screw to open the door,
wherein the opening and closing module comprises:
a drive module configured to provide a rotation that is converted to linear reciprocation of the opening and closing module relative to the lead screw; and
a planetary gear reduction module configured to transmit the rotation of the drive module at a preset gear reduction ratio, and
wherein the lead screw is disposed along a rotation center of the drive module.

2. The door opening and closing apparatus for a vehicle of claim 1, wherein the planetary gear reduction module comprises:
a gear housing;
a sun gear coupled to a rotor provided at the rotation center of the drive module;
a plurality of first planet gears disposed between the sun gear and the gear housing; and
an output gear rotatably coupled to the first planet gears, the output gear being rotated by a revolution of the first planet gears to move relative to the lead screw.

3. The door opening and closing apparatus for a vehicle of claim 1, wherein the planetary gear reduction module comprises:
a gear housing;
a sun gear coupled to a rotor provided at the rotation center of the drive module;
a plurality of first planet gears disposed between the sun gear and the gear housing;
a carrier having a first side to which the first planet gears are rotatably coupled, the carrier being rotated due to a revolution of the first planet gears;
a plurality of second planet gears disposed around a central gear provided on a second side of the carrier; and
an output gear rotatably coupled to the second planet gears, the output gear being rotated by a revolution of the second planet gears to move relative to the lead screw.

4. The door opening and closing apparatus for a vehicle of claim 2, further comprising:
a boot cover provided between a first end of the gear housing and a first end of the lead screw to surround the lead screw.

5. The door opening and closing apparatus for a vehicle of claim 3, further comprising:
a boot cover provided between a first end of the gear housing and a first end of the lead screw to surround the lead screw.

6. The door opening and closing apparatus for a vehicle of claim 2, further comprising:
a bushing or bearing that supports a first end of the rotor at a second end of the gear housing.

7. The door opening and closing apparatus for a vehicle of claim 1, wherein the drive module comprises:
a hollow rotor;
a brushless direct current (BLDC) motor that provides a torque to the rotor; and
a motor housing that surrounds an exterior of the drive module and coupled to the planetary gear reduction module.

8. The door opening and closing apparatus for a vehicle of claim 7, wherein the drive module comprises a magnet brake disposed between a second end of the rotor and the motor housing.

9. The door opening and closing apparatus for a vehicle of claim 8, wherein the magnet brake comprises:
a first magnetic body provided on an outer circumferential surface of the second end of the rotor; and
a second magnetic body provided on an inner circumferential surface of a second end of the motor housing and arranged to face the first magnetic body.

10. The door opening and closing apparatus for a vehicle of claim 9, wherein the magnet brake interferes with rotation of the rotor at one or more preset positions by generating magnetic attraction between the rotor and the motor housing as the first magnetic body and the second magnetic body, having opposite polarities, are arranged to face each other.

11. The door opening and closing apparatus for a vehicle of claim 1, further comprising:
a bracket coupled to the other of the door or the body,
wherein the opening and closing module is rotatably coupled to the bracket.
